(19) United States
(12) Patent Application Publication
(10) Pub. No.: US 2009/0216686 A1
(43) Pub. Date: Aug. 27, 2009

(54) MAIL FRANKING AND TRACKING METHOD

(76) Inventors: Frederic Jouvin, Batz-sur-mer (FR); Jean-Luc Jouvin, Batz-sur-mer (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/814,938

(22) PCT Filed: Jan. 27, 2006
(86) PCT No.: PCT/FR06/50065

§ 371 Date: Jul. 27, 2007

(30) Foreign Application Priority Data
Jan. 27, 2005 (FR) 0500858

(51) Int. Cl. G07B 17/02; G06Q 30/00; G06Q 10/00; G06Q 90/00; G06F 17/30; G06Q 20/00; H04L 9/32; G06F 17/40; H04W 4/12; G05B 19/00

(52) U.S. Cl. 705/402; 705/34; 705/404; 705/407; 705/408; 705/410; 705/411; 705/500; 707/104.1; 455/466; 340/5.1

(57) ABSTRACT

The invention relates to a method of franking of mail such that it can be tracked by carriers and mail-routing services. More specifically, the invention relates to a method of franking and tracking mail, such as letters or parcels, sent by at least one sender through a distribution network which is equipped with an information system (SI). The invention is characterised in that it comprises the following steps, namely: a first pre-franking step (200 and 210) in which the mail is franked by a user, including a step consisting in affixing an identification means to each mail item, which can be used to identify each item in a unique manner and which contains information that identifies the item, said identification information comprising at least one part identifying the mail shipping rank which can vary with each mail item; and a step consisting in weighing the item and determining the postage price required by the carrier in order to route the item to the recipient (230) depending on the shipping options and complementary services requested by the sender of each mail item.

This invention relates to the field of franking and tracking of dispatches by mail transport companies, express mail or package carriers, hereinafter denoted “the distributor”.

The present invention concerns more particularly a method of franking and tracking dispatches, of the letter or package type, sent by at least one sender to at least one recipient over at least one distribution network. The method comprises a mail pre-franking step performed by the senders, followed by a mail franking step performed by the distributor, then by a step of transporting the dispatch to the recipient with dispatch tracking being implemented throughout its transport while permitting the automatic sending of an acknowledgement of receipt when the dispatch reaches its destination.

The prior art already acknowledges many patents related to mail franking, such as, for example, patent FR2817382. In these patents related to franking, the inventors always tried to find innovative solutions to replace the paper stamp by a protected “Electronic” equivalent, in the form of a bar code or a RFID computer chip. Generally, these “electronic stamps” also allow the implementation of additional services made possible by the use of bar codes or RFID chips capable of storing a large amount of coded information: By way of example, the “electronic stamp” generally incorporates an “electronic postal seal” making it possible to guarantee its authenticity and its cancellation in a digital way. The current electronic stamps, implemented by two-dimensional bar codes, also incorporate numerous data useful for the processing of the mail by the transport companies: Name and address of the sender, destination postal code, and even sometimes destination address, weight of the dispatch, date, value of the stamp or the franking, registered package request, information necessary to perform tracking of the mail, etc.

Based on these numerous patents, the postage industry has set new international standards intended for the creation of a new generation of mail franking machines. These franking machines of the new generation, intended mainly for corporations and governmental agencies, offer extended possibilities due to these new standards, which define and characterize the “electronic stamp”.

Although these solutions are very effective for businesses, for the individual, the possession of a franking machine remains a problem that has not yet found an elegant solution. That is, the “electronic stamp” implements complex patented processes, including data encryption, weighing of the dispatches, the need to have opened and credited a customer account with the transport company . . . . Further, these technologies, as they have been imagined, cannot reasonably be expanded to individuals because of their cost, their complexity and the additional spatial clutter of such a machine. Finally, for security reasons, it would not be recommended to deploy this type of technology in individual residences because of the risks of fraud and piracy: By way of example and illustration, and for the same security reasons as well as because of the similar technical architectures employed, it is noted, for example, that in the field of Credit Card Banking, only businesses and companies are equipped with EPT (Electronic Payment Terminals). Giving direct access to franking machines to individuals would be equivalent to giving these individuals direct access to the electronic payment terminals, which is of course not desirable, nor even appropriate for security reasons . . . .

In order to get around this problem, the two leading groups in the development of franking machines, namely the NEOPOST and PITNEY BOWES companies, among others, have decided to use an intermediate solution that nevertheless allows individuals to use and buy “Electronic Stamps” without being in possession of a franking machine. The technical and technological solution adopted by the postal industry is somewhat disappointing; their solution consists in an Internet Web site (See, for example, the site www.stamps.com for USPS), made available to the public, and which makes it possible, once an account has been opened, to download images of “Electronic Stamps”, generated in real time by the Internet site, and paid online. Said stamps thus bought and downloaded must then be printed by the user via his personal computer and printer. The purchase of these “Electronic Stamps” on the Internet requires that the users know the weight of the dispatches they are going to send: It is therefore necessary to have an electronic balance close at hand to be able to buy these “Electronic Stamps”. Therefore, some sites propose acquiring a small electronic balance to plug into a USB port of the user's computer, thus transforming his personal computer into a sort of hybrid franking machine . . . .

This solution can appear attractive on paper, nonetheless, its use remains very laborious and time-consuming. That is, it requires using an Internet site after having subscribed to it, having credited his/her account and/or using a dedicated program to be downloaded to the user's PC. The objective is then to generate a bar code using said program on the user's PC (The program in question being in communication with a special server via the Internet), or to download directly from the Internet site an “Electronic Stamp” as an image “ready to be printed”. The user must then print the “Electronic Stamp” on a self-adhesive label or directly on the envelope of his mail, or possibly on a sheet of paper that he will then cut and glue on his envelope, in order to frank it. In addition to the compulsory use of an Internet site that is far from being accessible to all users, this solution forces the users to own and use a credit card for the purchase of their stamps, as well as to have access to a printer, to a personal computer, to an electronic balance and to an Internet connection to be able to buy, materialize, and then use “Electronics Stamps”. Finally, it is often necessary to use a pair of scissors to cut out the bar code that the user has printed on a sheet of paper so as to then glue it onto the envelope (the insertion of an envelope into the “A4 tray” of an “Ink jet” printer remains a tricky operation, which often fails because of numerous “failures” or “paper jams” before succeeding in printing something correctly). All these operations are laborious, long, and do not really encourage the use of “Electronic Stamps” by individuals; it is even more so when these individual are traveling.

These above-described systems and processes actually correspond to a situation where the new technologies proposed for the purchase and use of “Electronic Stamps” by individuals are more constrictive and complex to use than their predecessor, the common paper stamp as we have known it for more than 200 years.

The conclusion comes naturally: The solutions proposed today, for individuals, in order to allow them to buy and use “Electronic Stamps” are unsatisfactory and deserve to be improved.

In the field of mail tracking, the prior art already acknowledges, in French patent FR 2 826 758 issued Oct. 24, 2003, a dispatch tracking method including a step of printing a bar code on each of the dispatches, said bar code being constituted by at least an identification part of the sender that is fixed for every sender, and an identification part of the shipping rank of said dispatch that is variable for each dispatch. This technique makes it possible to identify the sender and the rank of the mail in a unique manner, wherein this combination ensures the uniqueness of the dispatch for tracking its transport.

This solution is a first step in the automation and simplification of the process of tracking letters or packages for individuals, because, contrary to other solutions used, it permits automating the sending of acknowledgments of receipt to the senders when the mail reaches its destination.

The present invention intends to remedy the drawbacks of the prior art by proposing a new solution for the “Electronic and Protected” franking of dispatches, for individuals, without the need to have complex machines, a computer, a printer, an electronic balance and a pair of scissors with or without the need to connect to Internet purchase sites and to download “electronic stamps”.

Such is the purpose of this invention: To propose an innovative process making it possible to reduce the tediousness of sending mail, for individual users, to a level less than that of sending an E-mail or dispatching mail with traditional “paper postage stamps”.

The invention applies therefore especially to individuals for whom franking machines are too costly to purchase and operate. With regard to companies, it is still in their interest to use franking machines. Generally the majority of companies already have efficient franking machines.

The method according to the present invention fulfills particularly well future expectations of letter and package routing and transport companies, for which the correct identification of the senders is necessary for the proper invoicing of services. It also fulfills well the expectations of individuals, allowing them to send packages or mail by very easily printing a bar code or equivalent and by depositing the package or the mail in a mail box of the carrier, for example, La Poste (commercial name). Another remarkable advantage of the method according to the present invention is that it prevents the user from having to weigh his mail, buy stamps and frank his mail before depositing it in a letter box.

On the other hand, according to the present invention, the user advantageously no longer has to have and/or to know the franking price table according to the weight and the destination of his dispatch. Remarkably, according to this invention, the user no longer has to perform the calculation to determine the franking price of his dispatches in order to be able to send them. With the present invention, the cost of franking the dispatches is determined automatically by the distributor at its sorting centers.

Finally, the automatic determination of the franking cost by the distributor makes it possible according to the present invention to propose heretofore unknown services in the field of mail franking and pricing: it becomes possible to conduct invoicing as close as possible to the fair price of the transport service, or this price can finally be calculated according to the weight and the actual transport distance between the sender and the recipient. Generally, it becomes possible for the distributor to invoice its transport services to the nearest kilometer and the nearest gram. This new approach to invoicing, which, remarkably, is made possible by the present invention, also responds well to the concerns of the distributors, which will appreciate the possibility of proposing new and attractive invoicing models for their customers, but above all with the possibility of differentiating themselves markedly with respect to those of their competitors, by adopting fixed payment plans or economic models or marketing strategies impossible to implement with the technologies of the prior art.

The possibility of implementing these new “dynamic” (according to the distance traveled by each dispatch, among others) and customizable modes of invoicing for each sender is truly something noteworthy and should achieve great success among distributors as well as users, and it should allow them to build efficient differentiating strategies with respect to their competitors, in a particularly delicate context because the mail delivery market for individuals is set to be opened to competition in Europe in 2007.

For this purpose, the invention concerns, in its most general meaning, a method of franking and tracking dispatches, of the letter or package type, sent by at least one user sender over at least one distributor network equipped with an information system (IS), containing:
a first step of pre-franking said dispatches by a user comprising a step consisting in placing an identification means on each of the dispatches, said identification means including “identification information” making it possible to uniquely identify said dispatch, said identification information being constituted by at least an identification part of the shipping rank of said dispatch, which is variable and unique for each dispatch,
a step of weighing and determining the necessary franking price by the distributor to route the dispatch according to the service options requested by the sender,
a step of reading the identification means on the dispatches and verifying, in the IS, the validity of the identification information read in said identification means, and
if said identification information is valid and authentic, a step of invoicing the amount of the transport service to the user, including the options and complementary services possibly requested by the sender.

In particular, the method further comprises, if the identification information is valid, a step of placing a franking means having a market value corresponding to the franking determined.

From a practical point of view and by way of example, the placing of a franking means having a market value on the mail or package can be carried out by the distributor, by printing, using a special franking machine, an “Electronic Stamp” such as is currently defined in the norms and standards of the postal industry in Europe. In the near or medium future, this placing of a franking means having a market value could consist, for example in the automated pasting, on the mail or package, by means of a suitable franking machine, of a RFID chip constituting an “Electronic Stamp”.

In a particular embodiment, the method further comprises placing an electronic date stamp or an electronic mark or an electronic seal. The latter makes it possible to indicate, among others, the date, the time and the references of the sorting center that took custody of the dispatch. This placing of a dating means can be made by printing a bar code or by placing an RFID chip constituting an “Electronic Seal.”

In a particular embodiment, the electronic dating or electronic seal means, as well as the possible franking means having a market value (Electronic Stamp) placed on the dispatch may be physically implemented, in the same device (Bar code representing both an electronic stamp AND an electronic seal, or RFID chip including both the data of an electronic stamp and of an electronic seal). In one particular embodiment of the invention, if the means constituting the identification means of each dispatch is an RFID chip and this chip can be reprogrammed, then the placing of the franking means having a market value (of the electronic stamp), and/or at least the electronic dating means (electronic seal, electronic post office seal) can consist in the partial reprogramming by the distributor of the RFID identification means of the dispatches using a suitable device in order to add to it, in addition to the identification data of the dispatches, the data required for implementing the franking means having a market value (electronic stamp), and/or the electronic dating means and/or the electronic postal seal. The advantage of this system is that there is a reuse of the RFID chip used by the user sender as “means for identification of the dispatches” and that the distributor avoids the application of a new RFID chip, which, for the distributor, is an important gain of time and money and greatly facilitates the placing of the electronic franking means and/or electronic dating means and/or electronic postal seal means. A particular version could be considered with a complete reprogramming of said RFID chip or the data of the electronic franking means and/or electronic dating means and/or electronic postal seal would completely erase and replace the identification information of the dispatches coming from the pre-franking step. This last variant has the additional advantage that it allows the mail to be “anonymous” when it is in transit in the distributor's network . . . .

In an embodiment, said step of invoicing the franking of the dispatch as well as the complementary services and service options possibly requested by the sender is performed, from a practical point of view, starting from a surtaxed SMS, MMS or EMS (Premium Service) telephone message sent or received on the sender's cell phone, thus making it possible to perform the micro-payment. Other micro-payment techniques can be used according to embodiments of the present invention. In addition, it is also possible to consider a micro-payment starting from a call from a surtaxed telephone number (Audiotel), or from the use of available means of micro-payment on the Internet, such as, for example, the WHA system developed by Wanadoo and France Telecom. It is also possible to use the Kiosque Micro (Developed by France Telecom), which allows Internet access by using a special surtaxed number. The use of the Minitel's surcharged Kiosks (3615, 3616) could be also an interesting technical solution. Remarkably, since this invention allows the user to send mail or packages when travelling, the use of the surtaxed SMS, EMS, MMS messages appears as the preferred micro-payment means for this invention.

In particular, said method further comprises a step of automatically sending at least one SMS, MMS, EMS telephone message or an Email, Fax or even dispatching a paper receipt, representing an acknowledgment of receipt when the mail has reached its destination. In addition, the implementation of this invention also makes it possible to achieve a traditional mail tracking by consulting the status of a dispatch by means of an Internet site, by indicating the shipping rank number, or the user number and the shipping rank number of the mail, according to embodiments.

In a particular embodiment, said method includes, in the procedure of placing a means of pre-franking the mail:
a step of identifying said user by the distributor's I.S.;
a step of transmitting the identification information of the dispatch between the user and the distributor; and,
a step of activating said identification part of the shipping rank by the distributor in the IS.

In this embodiment, it is the transmission and the prior validation of the rank identification numbers used between the user and the distributor that makes it possible to guarantee their authenticity and their validity when they are used.

In another embodiment, there is no longer any step of transmitting the shipping rank identification part between the user and the distributor. The validation of the shipping rank identification numbers is carried out by an electronic signature process, through the user device, of the identification information of the dispatch (including the shipping rank identification number), then verification of said electronic signature by the distributor's IS. In a preferred embodiment of the invention, the electronic signature must at least concern the shipping rank number, but all the identification data of the dispatch can actually be signed without problems in the present invention.

In a variant of this embodiment, the signature can be advantageously replaced by a validation code that guarantees the validity of a given identification rank number. To generate the validation code corresponding to an identification rank number, a database local to the user's device is then queried, and in one preferred embodiment, for example, the validation code corresponding to a particular rank number is sought in the so-called database of validation codes. At the distributor side, the verification of the validity of the validation code of a dispatch is performed by consulting a copy of this same database of validation codes, stored for each user in the database of the users in the distributor's information system. The distributor's IS then queries its own database of “control” validation codes, corresponding to the mail user of whose identification information it tries to verify the validity, and obtains the validation “control” code corresponding to the mail rank identification number of said mail. To be valid, the validation code obtained by the distributor using its own “control” validation code database must be identical to the one generated by the user's device, and recorded in the identification information of the identification means of the dispatch.

Several similar variants and techniques known in the prior art may also be used. In comparison with the validation technique by electronic signature, based on techniques of public key/private key encryption, this verification technique of the authenticity by a validation code is based on a unique key technique, or the same validation code base must be registered both in a database of users, and also in a distributor database, for each user. The validation code databases are preferably different for each user in order to increase the security. The validation code can be dependent, not only on the rank number, but also, possibly, on other variables present in the identification information of the dispatch. However, it would then substantially increase the number of entries of said validation code database, making it difficult to exploit. Indexing the validation codes solely on the rank number of each mail seems therefore to be the most optimal solution.

Thus, at the time of said step of reading the identification means on the dispatches and verifying the validity of the identification information contained in them, the distributor, according to embodiments (according to the validation techniques of the identification information of the dispatches retained), verifies the validity of an electronic signature or a validation code, which is preferably a function of the rank number.

Only the dispatches having an authentic electronic signature, or a valid and not yet used identification code, are considered as having valid identification information and are therefore allowed to be routed and invoiced to the sender.

In particular, said step of placing an identification means consists in a step of printing, via the pre-franking order printing device, a pre-franking order on at least one dispatch.

According to a variant, said step of placing an identification means consists in programming, via a suitable device, an RFID chip on at least one dispatch, wherein said RFID chip can be indifferently already incorporated in the dispatch or subsequently glued on it, and said chip further comprising, after said programming, the identification information of the dispatch.

Possibly, said identification means further comprises an identification part of the user sender of the dispatch, which is invariable and unique for each user and/or a part for ordering service options, which is variable for each dispatch.

In this case, the unique identification of the dispatch is made by the set identifier of the shipping rank and identifier of the user, wherein these two identifiers can be transcribed over a limited number of characters, for example six characters each.

On the contrary, when only the rank number is present on the dispatch, then it must be unique by itself, which is why it is generally coded with a more significant number of characters, for example 12.

In particular, said method can further comprise a step of indicating, on said dispatch, a distinctive visual mark if a service options order part comprises the service of sending an acknowledgment of receipt to the user sender, and if this service is activated. This distinctive mark allows the postman to note immediately and more easily the tracked dispatches, and to then proceed to reading their identification means when he distributes the dispatches in question to the recipients.

In an embodiment, said shipping rank identification part is generated at the user level by said device and said transmission step consists in sending at least the rank identifier by the user to the distributor.

In particular, said method further includes a step of acknowledging the rank identifier activated by the distributor to the user.

In a particular embodiment, the method comprises, in addition and prior to the step of placing an identification, transmission and activation means, a request from the user to the distributor triggering a step of generating said rank identifier by the distributor, which identifier is then activated by the distributor at the time of said activation step in the IS. In particular, said transmission step consists in the distributor sending said activated rank identifier to the user. According to one variant, said generation step is accompanied by the generation, by said distributor, of a pre-franking order comprising the identification means making it possible to uniquely identify the dispatch, and said transmission step consists in said user downloading said pre-franking order via a digital network.

In particular, said device does not include means for communicating with a communication network, but it includes user-interface means, and then said user performs the link between said device and said communications network when communication is required with the IS.

In a variant, said device comprises communication means for communicating with a communications network, the communication means being hard-wired or wireless.

In particular, said transmissions between the user and the distributor are carried out by communication means of the telephone message (SMS, MMS, EMS) type.

The advantage of the SMS, MMS type messages over GSM is to ensure a secure identification of the message recipient or of the message sender.

Other transmission means such as the Internet can also be used, with all the transmission protocols known in the prior art at the Internet and TCP/IP level. Further, since using the Internet does not make it possible to guarantee the implicit identification of the user at the distributor's, an identification step, for example, with a login and a password, may be necessary in order to validate authentication of the user at the distributor's I.S.

In a particular embodiment, said rank identifier information transmitted at the time of the transmission step is encrypted.

According to a variant, the identification information of the dispatch contained in the identification means placed on the dispatches is encrypted.

In particular, at the time of said transmission, the identification information is signed by means of a digital signature.

The means of encryption and signature will not be described in this document, because they are extensively known from the prior art. In addition, it would be advantageous to use a means of encryption and double key signature (public key and private key), but other means of encryption and signature known from the prior art can be used.

Possibly, the rank identifier is generated in a pseudo-random manner. The identifier generation will use an algorithm, preferably an algorithm that makes it possible to avoid that the same number be regenerated a second time. The implementation of such an algorithm can require maintaining a small database making it possible to list the numbers already generated. With regard to the embodiment of the present invention using a validation code and a database of validation codes to validate the identification information of the dispatches, it will be necessary to plan on implementing, on said user device, a mechanism for “loading” the validation codes in the database when all rank numbers have been generated and used for a given user. This search can be implemented by download, by recharging using a smart card, or by purchasing a chip card containing a “new validation code database”.

The method can also further comprise a step of identifying a user on said device. If the device uses a chip card, this identification can be performed by means of a smart card itself, in the same way as the SIM cards of the GSM telephones, with the entry of a PIN code on the keypad of the telephone. Said smart card comprising user information makes it possible to operate said device, and possibly, the databases necessary for the operation of the algorithm for generating the pseudo-random rank numbers previously described, or of the database of validation codes necessary for the operation of the embodiment in which the identification information of the dispatches is validated using a validation code.

The invention also concerns a system making it possible to implement the method comprising at least one database presenting a data table of the validated numbers listing the validated shipping rank identifiers, a user data table listing the personal information of the users, as well as a table containing the information of the dispatches that have the service of sending an automatic acknowledgment of receipt. The use of the mail franking and tracking service according to the present invention, by a user, requires a prior registration of this user in the distributor's various databases, and requires that the user be provided with a device for generating customized identification means with his own data. Customization is preferably performed using a smart card containing the information and the parameters of each user.

Finally, said device of the user can be a dedicated device, having or not capabilities of communicating directly over hard-wired or wireless telecommunications networks. Said device can be a personal computer, equipped with a printer, or a RFID chip programmer, and suitable software. It is also possible to consider software making it possible to transform a “personal assistant” of the Palm type into a device for generating dispatch identification means. The same solution can be considered with cell phones. In this case, a printer or RFID chip programmer external to the phone and/or the personal assistant will be required.

In an embodiment, said system further comprises a message management server connected to a communications network and capable of processing the communications coming from the users over at least a telecommunications network of the type Internet, GSM, GRPS, UMTS, X25 . . . .

Finally, in an embodiment of the invention, an electronic “acknowledgement of franking” message of each dispatch, is sent automatically after the step of weighing and franking each dispatch by the distributor's IS.

Finally, all data transmissions between the user and the distributor should preferably give rise to an authentication, a login, or a prior identification of the user, as well as any use of the user device, when it implements an embodiment without transmission. Just like for a banking card or a cell phone, the method according to this invention is a “payment method” for the franking of user mail, and must therefore include any login, identification and authentication techniques necessary to guarantee its secure operation and to protect the user from any fraudulent use of his equipment and/or his account by unauthorized and/or malicious people, according to a model and an approach preferably similar to that employed for banking cards or cell phones.

The invention also concerns a method of franking and tracking dispatches, of the type letters or package, sent by at least one user sender to an address of at least one recipient, over a distributor network provided with an information system (IS), containing:
a first step of pre-franking said dispatches by an user, comprising, among others, a step consisting in placing an identification means on each of the dispatches, said identification means being characterized in that it makes it possible to uniquely identify each dispatch due to the dispatch identification information that it contains, said information being constituted by at least one part for identification of the mail shipping rank, which is variable for each dispatch,
a step consisting, for the user, in posting his pre-franked dispatches in a mail box of the distributor,
a step of weighing and determining the price of the required franking, performed by the distributor for each dispatch, in order to route said dispatches to their respective recipients, according to the dispatch options and complementary services requested by the user for each of said dispatches.

In particular, said dispatch pre-franking step further comprises, for each dispatch:
a step of identifying the user,
   a step of generating said shipping rank identification part for said dispatch,
   a step of validating the identification information of said dispatch,
a step of generating the identification means for said dispatch.

According to an embodiment:
said step of generating said shipping rank identification part for said dispatch is carried out by the user, by means of a suitable device,
said generation step is followed by a step of validating the identification information of the dispatch, characterized in that it further comprises:
   a first step, performed by the user, of transmitting at least said shipping rank identification part of said identification information of the dispatch to the IS of the distributor by means of a suitable equipment,
   followed by a second step, performed by the IS of the distributor, of registering at least said shipping rank identification part of the dispatch received in a data table of valid rank numbers in the IS of the distributor,
   followed by a third step, performed by the IS of the distributor, of transmitting at least one confirmation of the validation of the identification information of said dispatch,
said validation step is followed by a step of generating the identification means of said dispatch to be placed on said dispatch, from the identification information of said dispatch, after receipt by the user, by means of suitable equipment, of said confirmation of the validation of the identification information of said dispatch.
   According to a variant:
said step of generating said shipping rank identification part for said dispatch is characterized in that it further comprises:
   a first step, performed by the user, of transmitting, by means of a suitable equipment, at least the request for generation of a shipping rank identifier for said dispatch by the IS to said IS of the distributor,
   followed by a second step, performed by the IS of the distributor, of generating said shipping rank identification part of said dispatch, after receipt by the IS of the distributor of this generation request,
said generation step is followed by a step of validating the identification information of said dispatch, characterized in that it further comprises:
   a first step, performed by the IS of the distributor, of recording at least said rank identification part of said dispatch generated in a data table of valid rank numbers in the IS of the distributor,
   followed by a second step of transmitting to said user at least said rank identification part generated by the IS of the distributor,
said validation step is followed by a step of generating the identification means of said dispatch to be placed on said dispatch, from the identification information of said dispatch, after receipt, by the user, by means of suitable equipment, of the shipping rank identification part of said dispatch.

In particular, said step of generating and validating the shipping rank identification part of the dispatch is accompanied by the generation by said distributor and by the transmission to the user, over at least one telecommunications network, of an image file graphically representing a pre-franking order containing the identification information of the dispatch in the form of a single- or bi-dimensional bar code thus constituting said identification means to be placed on the dispatch making it possible to identify the dispatch in a unique manner, and the user sender in a sure and protected manner.

According to various embodiments:
said identification step is performed via an authentication of the user at the IS of the distributor prior to any transmission between the user and the IS of the distributor,
for each dispatch, at the time of said transmission steps between the IS of the distributor and the user, all or part of the transmitted information is encrypted or signed by means of a digital signature, and said digital signature is added to said transmitted information,
for each dispatch, all or part of said identification information present in the identification means of each dispatch is encrypted or signed by means of a digital signature, and said digital signature is then added, for each dispatch, to said identification information of each dispatch, prior to said step of generating the identification means of each dispatch.

According to another variant:
said step of generating said shipping rank identification part for said dispatch is performed by the user by means of suitable equipment,
said generation step is followed by a validation step consisting in the generation of a digital signature, of all or part of the identification information of said dispatch and of said shipping rank identification part of said dispatch, and said digital signature then being added to said identification information of said dispatch,
said validation step is followed by a step of generating the identification means of said dispatch to be placed on said dispatch, from the identification information of said dispatch including said signature.

According to a further embodiment:
said step of generating said shipping rank identification part for said dispatch is performed by the user by means of suitable equipment,
said generation step is followed by a validation step consisting in a step of generating a validation code, said code being obtained by reading, in a data table of validation codes, the code corresponding to said shipping rank identification part of said dispatch, and said code being added to the identification information of said dispatch,
said validation step is followed by a step of generating the identification means of said dispatch to be placed on said dispatch, from the identification information of said dispatch including said validation code, and
said data table of validation codes is characterized in that it is different for each user, and in that a copy of this validation code table is stored in the appropriate equipment of the user, and in that another “control” copy of this same data table is stored in the data of said user, in the user data table in the IS of the distributor, for each user.

Possibly, the method further comprises, prior to said weighing and price determination step, for each dispatch:
a step, performed by the distributor, of reading, using suitable equipment, the identification information of said dispatch contained in the identification means of said dispatch placed on said dispatch,
a step, performed by the distributor, of verifying the validity of the identification information of the dispatch read in said identification means of said dispatch,
if said verification step is a success, triggering said weighing and necessary franking price determination step, performed by the distributor, to route said dispatch to the recipient, according to the dispatch options and the complementary services requested by the user for said dispatch.

According to various embodiments:
said verification step by the distributor consists in the verification of the presence, in said data table of valid rank numbers, of said shipping rank identification part read in said identification means of said dispatch,
said verification step by the distributor consists in the verification of the validity of the digital signature read in the identification means of said dispatch at least with respect to the shipping rank identification part of the identification information of said dispatch read in the identification means of said dispatch,
said verification step by the distributor consists in the verification of the matching of the validation code read in the identification means of said dispatch with the “control” validation code obtained by reading, in the data table of validation codes corresponding to the user of said dispatch and stored in the data table of users, the validation code corresponding to said identification part of the shipping rank of said dispatch read in said identification means of said dispatch,
for each dispatch, said identification information of said dispatch contained in the identification means of said dispatch further comprises an identification part of the user sender of said dispatch, which is invariable and unique for each user, and said verification step can further comprise the verification of this identification data of the user,
the method comprises, for each dispatch, subsequent to said weighing and franking price determination step, an additional step, performed by the distributor, of placing, by means of suitable equipment, a franking means having a market value corresponding to said previously determined franking price,
the method comprises, for each dispatch, subsequent to said weighing and franking price determination step, an additional step, performed by the distributor, of placing, by means of suitable equipment, means for dating the custody exchange of the dispatch, said dating means corresponding to an “electronic date stamp” or to a “electronic seal”,
the method further comprises, at the time of said franking price determination step, for each dispatch by the distributor, a step of calculating the distance between the point of deposit of said dispatch by the user and the destination address of said dispatch, and said franking price determination is also performed as a function of said calculated distance,
for each dispatch, said identification information of said dispatch contained in said identification means placed on said dispatch at the time of said pre-franking step further comprises a part for ordering service options and complementary services, which is variable for each dispatch.

Possibly, for each dispatch, said identification information of the dispatch contained in said identification means of the dispatch further contains, in the service options and complementary services order part, a part for ordering a service option for automatic sending of an acknowledgment of receipt to the user when said mail is given to the recipient,
the method further comprises, for each dispatch:
   an optional step of indicating, on said dispatch, during the pre-franking step of said dispatch, a distinctive visual mark on said dispatch if the service options and complementary services order part of said dispatch contained in the identification means of said dispatch contains a service option order part for automatic sending of an acknowledgment of receipt to the user, and if said option has been activated,
   a step, performed by the IS of the distributor, of automatically sending an electronic “acknowledgment of receipt” message to the user via at least one telecommunications network if said dispatch is correctly given to the recipient, and if said dispatch contains said visual mark, or if the service options and complementary services order part of said dispatch contained in the identification means of said dispatch contains a service option order part for automatic sending of an acknowledgment of receipt to the user, and said option is activated for said dispatch,
for each dispatch, said step of generating and placing the identification means of said dispatch consists in programming an RFID chip by suitable equipment, wherein said RFID chip can be already incorporated in the dispatch packaging or inserted beforehand or not into the dispatch, or subsequently glued to said dispatch, and said chip further comprises, after said programming, said identification information of said dispatch,
for each dispatch, said step of generating and placing the identification means on said dispatch consists in printing, by suitable equipment, a bar code to be placed on or glued to said dispatch, wherein said bar code can be printed directly on said dispatch, and wherein said bar code further comprises said identification information of said dispatch in the form of a bar code,
the method comprises, for each dispatch, subsequent to said weighing and franking price determination step, a step of automated sending, by the IS of the distributor, of an electronic “acknowledgment of franking” message to the user for said dispatch via at least one telecommunications network, wherein said electronic message can contain all or part of the identification information of said dispatch, and can also contain all or part of the information resulting from the weighing and franking price calculation step for said dispatch,
the method comprises, for each dispatch, subsequent to said weighing and franking price determination step, a step of invoicing said price to the user by a means of payment. Possibly, for each dispatch, said invoicing step is performed from the sending by the user of a surtaxed SMS+, EMS+, MMS+, or Audiotel (Premium Service) telephone message to the IS of the distributor via at least one telecommunications network, or by receipt by the user of the “acknowledgment of franking” message of said dispatch sent by the IS of the distributor in the form of an SMS+, MMS+, or EMS+ message via at least one telecommunications network, the sending or the receipt of said SMS+, EMS+, MMS+, or audiotel message making it possible to perform a micro-payment by the user for the cost of franking said dispatch,
for each dispatch, said generation of the rank identification part is a pseudo-random generation,
said user identification step is performed by the authentication of the user on said equipment,
said suitable equipment of each user can contain a chip card containing all parameterization information required for the operation of the method, wherein said equipment can also incorporate data transmission means compatible with wireless or hardwired telecommunications networks,
for each dispatch, if said identification means of said dispatch is constituted by an RFID chip, said step of placing a franking means having a market value or of placing a dating means is replaced by a step of partially reprogramming said RFID chip constituting said identification means of said dispatch, wherein said reprogramming step makes it possible to add the required additional data, to implement said “electronic dating” means or said “electronic stamp” franking means in the identification means of said dispatch in addition to the identification information of said dispatch,
   said transmissions of messages or said transmissions of information between the IS of the distributor and the user are performed over at least one telecommunications network.

The invention also concerns a system permitting the implementation of the method according to any one of the previous claims, characterized in that it comprises at least one database presenting a data table of validated numbers listing the validated shipping rank identifiers and the other identification information of the dispatches, a table listing the dispatches for which an acknowledgment of receipt message to the user has been requested, a data table of users listing the personal information of the users and means capable of processing, according to the data from said database, dispatches provided with pre-franking orders containing rank identification data and to perform the weighing and franking price determination of said dispatches if the rank identification data are valid with respect to the data contained in said database.

It is understood that the technical aspects previously evoked and described extensively below shall be able to form the object of a specific protection, each of these aspects being protected independently. Let us note the importance specifically of the different modes of pre-franking:
with generation by the user and validation by transmission;
with generation by the distributor and validation by transmission;
with generation by the user and validation by electronic signature;
with generation by the user and validation by validation code;
with use of a bar code;
with use of an RFID chip;
with downloading of an image generated by the distributor . . . .

The invention shall be better understood with the help of the description made below merely by way of explanation, of an embodiment of the invention, in reference to the attached figures where:

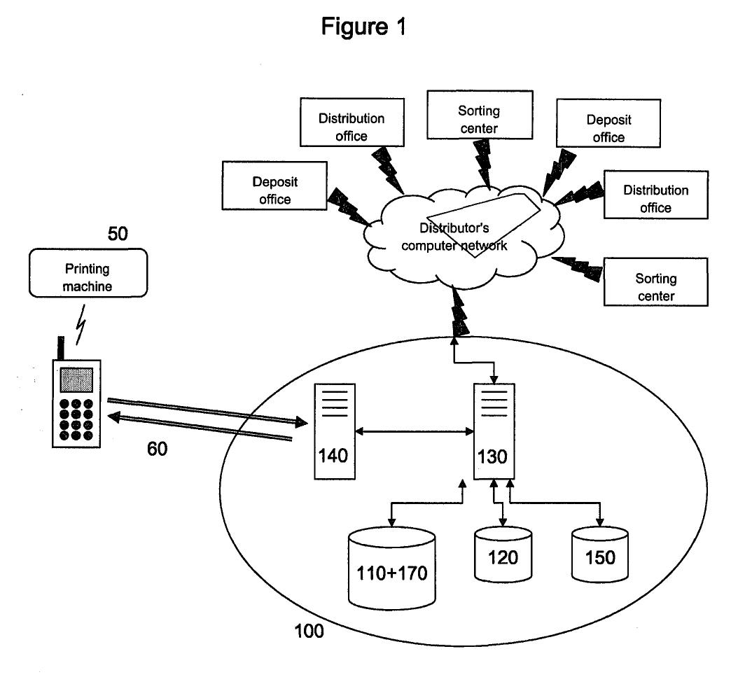

FIG. 1 illustrates a diagram of the principle of the device for franking and tracking dispatches according to the present invention;

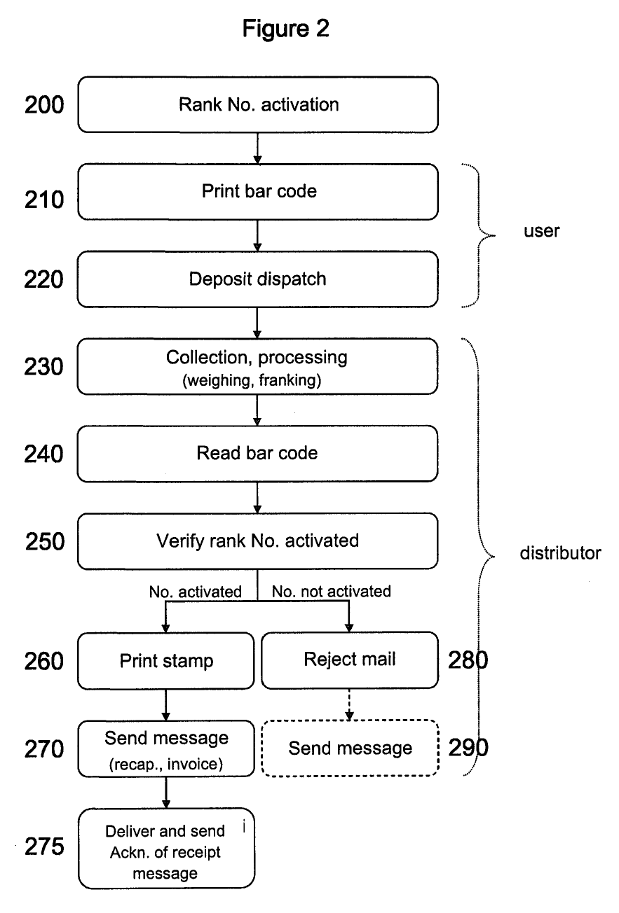

FIG. 2 is an organizational chart of the method of franking a dispatch according to the present invention;

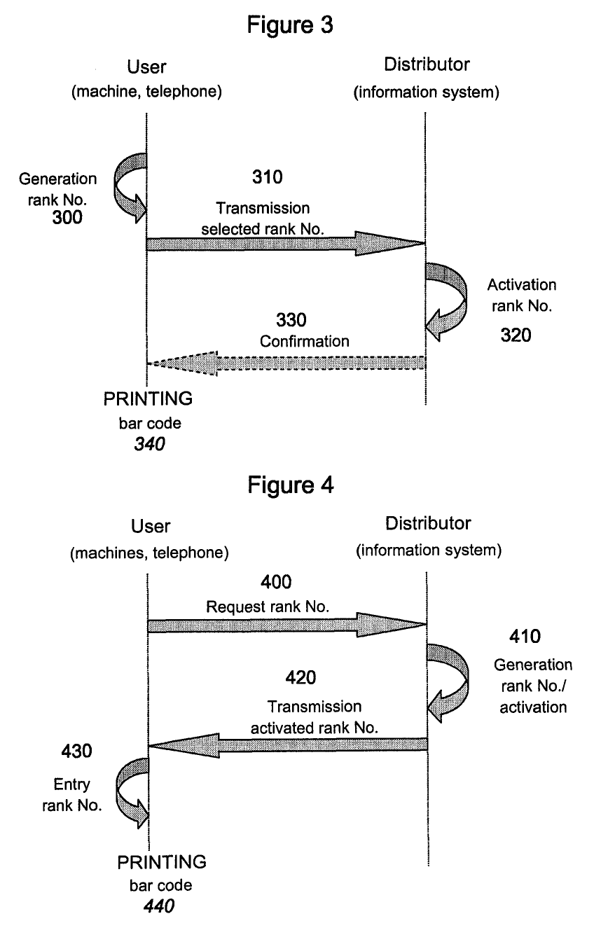

FIGS. 3 and 4 illustrate two methods of pre-franking dispatches by a user according to the present invention.

As described in the document FR 2 826 758 cited previously, the bar code that the sender prints on the envelope includes:
an initialization and termination part of the bar code;
an identification part of the sender (or user): it involves a unique number assigned to only one user;
an identification part of the shipping rank number: it involves a different number for each of the dispatches by a same sender;
a part for ordering service options, such as the sending of an acknowledgment of receipt and/or an acknowledgement of shipping the dispatch.

These three pieces of information make it possible to uniquely identify a dispatch shipped through the distribution network, and to automatically deliver, in a very short time, acknowledgements of deposit and of receipt without the sender having to consult an Internet site or an interactive vocal server, or a telematic minitel service, which is of major interest and an important convenience for the user.

Thereafter, the term “distributor” or “distribution company” refers to the structures or businesses responsible for transporting the packages and mail from the time of taking them into custody up to delivery to the recipient. In France, a distributor can be La Poste (commercial name) or any carrier of packages, goods, etc.

In an embodiment, the invention is a method, carried out by the user, of pre-franking dispatches, of the type packages or letters, sent by at least one user, said method comprising a step of printing a bar code, for example, as previously described, on each of the dispatches, the bar code including at least one part for identification of the shipping rank of the dispatch, this part being variable for each dispatch.

The method further comprises the transmission of the rank identifier used for a dispatch between the user and a distribution company's server, and the activation of that identifier by the distribution company's server.

The distribution network can be a postal distribution network such as the one of La Poste (commercial name) but also any other distribution network of goods.

The present invention relies on the activation of a rank identifier that is going to be used for a dispatch. This activation is carried out by means of a dedicated server of the distributor. For the user requiring this activation step, only the dispatch comprising this identifier is processed by the distribution body.

The user is initially registered with the distribution network by the filing of personal information recorded in a database of users (110) with which the user's unique identifier supplied by the distributor is associated. A more detailed description of the registration process and data transmitted is supplied in the above-mentioned patent. The database of users also contains the user's mobile telephone number in order to make it possible to send him messages of the type SMS, MMS or EMS, but also to make it possible to identify the user from his cell number.

The advantages that the use of the messages on GSM provides, as compared to the other solutions that can nevertheless be used within the scope of the invention, are to guarantee automatically a secure identification of the sender/recipient of the messages while transmitting information, but also to constitute a means of payment if the case arises. In some solutions not offering this guarantee, a personal identification code is added in the transmitted information.

Method of Franking and Tracking Dispatches.

The user who wants to send mail prints, using a dedicated device (50), for example, the one described in patent FR 2 826 758, a bar code including its unique user identifier, the rank identifier of the mail to be sent and the service option information (acknowledgements of sending/receipt) if there are any. Further details on the bar code are supplied in this aforementioned document. At no time does the user need to weigh his dispatch or to buy and attach a stamp having a market value. Here, the printed bar code has not been purchased, and therefore, it has no market value.

The user has previously activated (200) the rank number at the distribution body (see in the continuation of the description below) so that the latter can process the dispatch carrying this number and coming from the user whose identifier is contained in the bar code.

Method of Generation and Activation of Rank Numbers.

Generation by the User

In reference to FIG. 3, a first embodiment of the generation and activation of the rank number is proposed.

The apparatus (50) for printing the bar codes or a module that is connected to this apparatus generates (300) in a pseudo-random manner a new rank number at the user's request. The apparatus has a liquid crystal screen to display the number generated. This rank number is constituted by alphanumeric characters, for example, numbers. According to an embodiment, the rank numbers consist of at least two numbers. In particular, they are composed of four or six numbers. Contrary to the document FR 2 826 758, the rank identifiers are generated in a random or pseudo-random manner and comprise a larger number of numbers. This embodiment makes it possible to increase security since any pirate would have a harder time finding an active rank number among a million than among a hundred. The apparatus or device can comprise means for storing the last numbers generated to ensure that a number is not regenerated in too short a period, for example two months.

The user then edits an SMS message containing the rank number generated, then transmits it (310), via a telecommunications network (60), to the information system (IS) of the distributor. The IS is the combination of the technical and computer resources (servers, databases) at the distributor's level that make it possible to manage the dispatches, customers, . . . . It contains a server for managing the messages (140) linked to the telecommunications network and capable of receiving, issuing and processing connections. It is considered to provide the apparatus (50) with communication means (for example Bluetooth) with the telephone. The apparatus (50) then transmits the rank number to the IS directly via the telephone.

Possibly, the user can adjoin, for example, to the rank number, a field text making it possible to certify the dispatch, for example, “tax” or “invitation”. This field can then be mentioned in all exchanges between the user and the distributor in order to facilitate the recognition, for the user, of the dispatch concerned.

By using the communication means of the telephony type, the user ensures that the IS will be able to identify him securely: for example, the telephone number sending the telephone messages is unique to the user.

The IS activates (320) the rank number received by storing it in a database of active numbers (150), associated with the user's identifier, the latter having been recovered in the database of users using his telephone number.

When the rank number received is already present in the database (150) of active numbers for the same user, it means that it is already in use for a dispatch in progress. The information system then sends a message to the user to report it.

In an embodiment, the database (150) of active numbers contains, in addition, another field (for example, a “status” tag) making it possible to specify whether the number is only “active” (activated by the user, but the distributor has not yet taken custody of the mail having this rank) or it is “transport in progress” (the distributor has taken custody of the mail having this rank number).

The IS processes only the messages received from users and more precisely the telephone numbers of the users, numbers which are recorded in the database of users. When a message coming from an unknown number is received by the message management server (140), the latter can either ignore it, or send back a message informing that the user must register or modify his personal data.

Once the rank number has been activated (recorded in the dedicated database), the IS can send back a message (330) of the SMS type to the user to inform him that the rank number is activated and can be used for the dispatch of the package. The activation (320) and confirmation (330) steps must be carried out quickly, for example, in real time (less than the time required for the user's pre-franking operations, for example, one minute), so that the user knows whether he can use this rank number for the mail to be sent. In a particular embodiment, the release sent by the distributor's I.S. to the user can be replaced by the sending (downloading) of a file including a pre-franking order ready to be printed . . . .

This message also makes it possible to inform the user of the franking amount, and possibly to perform the payment, for example, via the use of surtaxed SMS.

Possibly, the activated rank number can be recovered by the user by calling up and identifying himself with a vocal server.

Other digital network technologies make it possible to perform the transmissions of messages between the user and the IS, for example, the Internet.

Use of a Dedicated Terminal

It is also foreseen that bar code printing terminals are available at the distributor's package deposit centers. These terminals have means for identification of the user who wishes to pre-stamp his package. Solutions for such means are present in the prior art, for example personalized chip cards (the user opens beforehand, at the distributor's, a management account of the dispatches in exchange for a personal card, this account being then used for invoicing), personalized RFID chips, a WiFi or Bluetooth connection with a light user terminal, . . . .

Thus, the user inserts his smart card in the terminal and chooses the services options he wants. This terminal, if it is connected to a network, can issue a request to recognize and to activate a new rank number. Otherwise it generates a rank number in a pseudo-random fashion, after which the user must activate this number.

The terminal then prints the bar codes containing the required information on the package.

Generation by the Distributor:

In reference to FIG. 4, a second embodiment of the generation and the activation of the rank number is proposed.

The user wants a valid and active rank number for the dispatch of a piece of mail. He sends a request (400), for example, in the form of a SMS message, to the distributor's message management server.

The information system identifies the user via the telephone number sending the SMS. This identification is implicit in the transmission mode of the request. Indeed, it is just as possible to implement encryption means by private key/public key or digital signature means making it possible to ensure a secure identification of the user by the information system.

The information system generates (410) in a pseudo-random manner a rank number not present in the database of active numbers and records it in this base with the user's identifier. By this operation (410), it ensures that the rank number generated is active.

Then, the information system sends a SMS message to the user (420) indicating to him the active rank number generated. The user then enters (430) this number in the bar code printing apparatus. He can, for example, use an entry keyboard linked to the device.

In a variant of the invention, the printing apparatus and the cell phone are provided with wireless communication means, of the Bluetooth or WiFi type. The rank number entry operation between the device and the telephone is simplified by the transmission of the rank number in question via these wireless communication means.

In another variant of the invention, the rank number is encrypted either by the printing apparatus or by the distributor's information system. Only the encrypted number is transmitted between the user and the distributor's IS whereas the non-encrypted number is printed in the bar code. The reverse is also possible, namely the printing of the encrypted rank number and the transmission of the non-encrypted number. The apparatus and the IS are the only ones to know the encryption and decryption algorithms, which can be specific to a machine (“hard wired” in the machine) or to a user (with the user's unique identifier as a parameter). The interest of encryption is to prevent a malicious person who could have intercepted the content of the transmission from printing a valid bar code, by encrypting the information exchanged with the I.S. Thus, when a person manages to extract one of the data sent (rank number in clear or encrypted), that person is not able to determine the associated rank number required for the activation.

In a particular embodiment, the user issues a request to the distributor's IS to generate a pre-franking order. This request can be formulated by any communication means: Internet, telephone, . . . . The distributor then generates a pre-franking order downloadable from the Internet. Secure means for identification of its associated dispatch is integrated in this pre-franking order. The pre-franking order is a graphic representation containing the identification means, for example, in the form of a single or bidimensional bar code, of a coded 2D image. The pre-franking order is then printed and is placed on the package to be sent.

If the distributor identifies the requesting user, then the identification means can contain the user's identifier plus a rank number generated by the IS: the combination of these two numbers is unique and ensures the secure identification of the package. Possibly, the user's identifier can remain unused (unrecognized user), in which case a rank number using a very large number is generated in a unique manner: this number by itself makes it possible to securely identify the package.

The distributor makes the pre-franking order available on the Internet to be downloaded, either by secure access with user identification or directly in response to the user's request. The user thus downloads this order and prints it before placing it on his package. At the time of downloading the order, there is indeed transmission of the shipping rank identifier between the IS and the user. This rank number is intrinsic to the pre-franking order.

Said pre-franking purchase order preferentially and advantageously consists in an “image” file representing a bar code, in a standard image format known from the prior art, such as, for example, a JPEG, GIF, BMP or even PDF file.

The advantage of this embodiment is that a pre-franking order ready to be printed and requiring no specific software is transmitted to the user. Thus, this embodiment has the advantage that it can be implemented using a computer connected to the Internet, a communicating PDA or a MMS mobile phone coupled to a printer, and without the need to arrange specific hardware or software to use the service and to print the printing order.

In this embodiment, the transmission of the pre-franking order can thus be performed, by the distributor, by sending an Email or a MMS containing an image file in a standard format, for example, in the JPEG, GIF, BMP or PDF format. But the transmission can also be performed by means of an FTP or HTTP server to which the user must connect to download the image file of the pre-franking order.

After printing (210) of the bar code on the envelope, the user deposits (220) his dispatch (letter or package) in one of the dedicated boxes or in one of the deposit centers belonging to the distribution network.

The distribution company then performs the collection at the postal centers and deposit boxes, and processes the mail in its sorting center. This processing can consist in weighing the mail, then determining the franking necessary for the distribution of said mail, by an electronic stamp, for example. An electronic stamp is understood as any means placed on the packages associated with the payment of the transport costs and requiring electronic means to perform reading of all or part of the information it contains. For example, an electronic stamp can be a RFID chip, or a coded printout.

At this juncture, the bar code of the envelope is read (240) by an appropriate device (automatic reading for example) to determine the sender's identifier, the service options to adapt the franking and the invoicing, and the mail rank number. Then, the company's information system is requested (request on the server 130) to verify (250) that this rank number on the envelope is indeed valid (active) for the sender. To this aim, the processing server compares the rank number read with those present in a database of active rank numbers.

If the rank number is valid, it is because the user has indeed requested activation of this number, which ensures that the dispatch has indeed been mailed by the user in question. The bar code is thus valid, the “status” tag of the database of active numbers is modified to “in progress” for the rank number, and the distributor can print (260) a stamp on the envelope, for example, an electronic stamp, using dedicated franking equipment. Numerous electronic stamp solutions are available in the prior art which, by the way, are already in operation, for example, in Italy.

If the rank number has not been activated in the database, then there is a usurpation, either of a user's identifier, or of a rank number. The mail is then rejected (280) by the distributor. Possibly, the distributor can inform (290) the user whose identifier is present in the bar code of the rejection, so that the user may correct the situation (i.e. activate the rank number) if he has forgotten.

If the rank number is valid, the mail is accepted into custody by the distributor at this stage. It then proceeds to transport it toward its recipient. At the time of delivery of the mail to the recipient (275), the rank number of this mail is then removed from the database of active numbers. The rank number is again available for a new dispatch.

In parallel, it sends (270) a specific message of the SMS, MMS or EMS type to the user's cell phone, making it possible, on the one hand, to report and summarize the processing information of the mail (mail taken into custody, options chosen, date, cost of franking, . . . ) and, on the other hand, to perform the micro-payment of the services requested: franking of the mail, printing of the electronic stamp, payment of the chosen service options (acknowledgement of deposit, of receipt).

During transport of the mail, new messages can be sent (275) to the user or to the recipient to inform them of the tracking of their mail. Elements for management of such mail tracking are provided by the patent FR 2 826 758, for example, a database for tracking the dispatches (120).

In order to report to the user regarding the tracking of his dispatch, it is envisioned to print a distinctive mark on the dispatch, for example, the letter “R” or a frame around the bar code, if the dispatch is being tracked. This printing takes place at the same time as the printing of the bar code since the choice of the tracking or not is specified at this time. This distinctive mark allows the postman, at the time of the delivery of the package, to know if the bar code must be read in order to send the tracking info (here, delivery) to the user sender. Portable machines to read these bar codes exist in the state of the art. These machines can be linked directly to the distributor's information system (link by telecommunications network, for example) to transmit the delivery information of the package to the sender in real time.

The method according to this invention ensures the strong identification of the user due to the bar code printed on the envelope and the prior operation of activating the rank number used in the bar code. The user must activate each rank number that he uses prior to its dispatch, this activation operation ensuring that only the user and the distributor's information system know the active rank numbers.

Micro-Payment

In a variant of the invention, other means of micro-payment can be used for the payment of the services requested by the user. Automatic withdrawal, payment via the Internet, payment by banking card via cell phone, can be considered; also, it is considered that the user can have an account, prepaid or not, at the distributor's, from which the appropriate amount of the transactions is withdrawn.

In one variant of the invention, the bar code printed on the envelope does not contain the identifier of the user sender. This variant guarantees the anonymity of the sender. The active rank numbers are then no longer indexed by the user identifier: they can have an increased length, for example eight or ten numbers.

In a particular embodiment, the information making it possible to uniquely identify the dispatches is parameterized in a chip, for example of RFID type, allowing easy reading from a distance. Possibly, the chip is already incorporated into the packaging of the package, or it is subsequently glued on the package to be sent, in which case the reading and franking process by the distributor is much easier to automate.

In this embodiment, the user has a machine for parameterizing the RFID chips operating in a manner similar to the machine for printing bar codes previously described: generation or entry of the rank number, presence of sender's number, choice of the sending options.

The user can also go to a postal center where an RFID parameterization terminal allows him, via a personal smart card, to edit the chips to be used.

In a particular embodiment, the mail boxes of the users of the service also possess a user identifier: bar code or RFID chip. The presence of that identifier allows the postman to verify that the recipient corresponds indeed to the one indicated on the package, and also to inform the recipient by sending an SMS message that a package is available, or to indicate the recipient's elements in the acknowledgment of receipt message provided to the sender of the dispatch.

1. Method of franking and tracking dispatches, of the type letters or package, sent by at least one user sender to an address of at least one recipient, over a distributor network provided with an information system (IS), which comprises:
a first step of pre-franking said dispatches by a user, comprising, among others, a step consisting in placing an identification means on each of the dispatches, said identification means being characterized in that it makes it possible to uniquely identify each of the dispatches using the dispatch identification information it contains, said information being constituted by at least an identification part of the shipping rank of the mail, which is variable for each dispatch,
a step consisting, for the user, in posting his pre-franked dispatches in a mail box of the distributor,
a step of weighing and determining the price of the required franking, performed by the distributor for each dispatch, in order to route said dispatches to their respective recipients, according to the dispatch options and complementary services requested by the user for each of said dispatches.

2. Method of franking and tracking dispatches, according to claim 1, wherein said dispatch pre-franking step further comprises, for each dispatch:
a step of identifying the user,
a step of generating said shipping rank identification part for said dispatch,
a step of validating the identification information of said dispatches,
a step of generating the identification means for said dispatches.

3. Method of franking and tracking dispatches, according to claim 2, wherein:
said step of generating said shipping rank identification part for said dispatches is performed by the user via suitable equipment,
said generation step is followed by a step of validating the information identification of the dispatch, characterized in that it further comprises:
a first step, performed by the user, of transmitting at least said shipping rank identification part of said identification information of the dispatch to the IS of the distributor by means of a suitable equipment,
followed by a second step, performed by the IS of the distributor, of registering at least said shipping rank identification part of the dispatch received in a data table of valid rank numbers in the IS of the distributor,
followed by a third step, performed by the IS of the distributor, of transmitting at least one confirmation of the validation of the identification information of said dispatch
said validation step is followed by a step of generating the identification means of said dispatch to be placed on said dispatch, from the identification information of said dispatch, after receipt by the user, by means of suitable equipment, of said confirmation of the validation of the identification information of said dispatch.

4. Method of franking and tracking dispatches, according to claim 2, wherein:
said step of generating said shipping rank identification part for said dispatch is characterized in that it further comprises:
a first step, performed by the user, of transmitting by means of a suitable equipment, at least the request for generation of a shipping rank identifier for said dispatch by the IS to said IS of the distributor,
followed by a second step, performed by the IS of the distributor, of generating said shipping rank identification part of said dispatch, after receipt by the IS of the distributor of this generation request,
said generation step is followed by a step of validating the identification information of said dispatch, characterized in that it further comprises:
a first step, performed by the IS of the distributors, of recording at least said rank identification part of said dispatch generated in a data table of valid rank numbers in the IS of the distributor,
followed by a second step of transmitting to said user at least said rank identification part generated by the IS of the distributor,
said validation step is followed by a step of generating the identification means of said dispatch to be placed on said dispatch, from the identification information of said dispatch, after receipt, by the user, by means of suitable equipment, of the shipping rank identification part of said dispatch.

5. Method of franking and tracking dispatches, according to claim 3, wherein said step of generating and validating the shipping rank identification part of the dispatch is accompanied by the generation by said distributor and by the transmission to the user, over at least one telecommunications network, of an image file graphically representing a pre-franking order containing the identification information of the dispatch in the form of a single- or bi-dimensional bar code thus constituting said identification means to be placed on the dispatch making it possible to identify the dispatch in a unique manner, and the user sender in a sure and protected manner.

6. Method of franking and tracking dispatches, according to claim 3, wherein said identification step is performed via an authentication of the user at the IS of the distributor prior to any transmission between the user and the IS of the distributor.

7. Method of franking and tracking dispatches, according to claim 3, wherein, for each dispatch, at the time of said transmission steps between the IS of the distributor and the user, all or part of the transmitted information is encrypted or signed by means of a digital signature, and said digital signature is added to said transmitted information.

8. Method of franking and tracking dispatches, according to claim 1, wherein, for each dispatch, all or part of said identification information present in the identification means of each dispatch is encrypted or signed by means of a digital signature, and said digital signature is then added, for each dispatch, to said identification information of each dispatch, prior to said step of generating the identification means of each dispatch.

9. Method of franking and tracking dispatches, according to claim 2, wherein:
said step of generating said shipping rank identification part for said dispatch is performed by the user by means of suitable equipment,
said generation step is followed of a validation step consisting in the generation of a digital signature, of all or part of the identification information of said dispatch and of said shipping rank identification part of said dispatch, and said digital signature then being added to said identification information of said dispatch,
said validation step is followed by a step of generating the identification means of said dispatch to be placed on said dispatch, from the identification information of said dispatch including said signature.

10. Method of franking and tracking dispatches, according to claim 2, wherein:
said step of generating said shipping rank identification part for said dispatch is performed by the user by means of suitable equipment,
said generation step is followed by a validation step consisting in a step of generating a validation code, said code being obtained by reading, in a data table of validation codes, the code corresponding to said shipping rank identification part of said dispatch, and said code being added to the identification information of said dispatch,
said validation step is followed by a step of generating the identification means of said dispatch to be placed on said dispatch, from the identification information of said dispatch including said validation code, and
said data table of validation codes is characterized in that it is different for each user, and in that a copy of this validation code table is stored in the appropriate equipment of the user, and in that another “control” copy of this same data table is stored in the data of said user, in the user data table in the IS of the distributor, for each user.

11. Method of franking and tracking dispatches, according to claim 1, further comprising, prior to said weighing and price determination step, for each dispatch:
a step, performed by the distributor, of reading, using suitable equipment, the identification information of said dispatch contained in the identification means of said dispatch placed on said dispatch,
a step, performed by the distributor, of verifying the validity of the identification information of the dispatch read in said identification means of said dispatch,
if said verification step is a success, triggering said weighing and necessary franking price determination step, performed by the distributor, to route said dispatch to the recipient, according to the dispatch options and the complementary services requested by the user for said dispatch.

12. Method of franking and tracking dispatches, according to claim 3, further comprising, prior to said weighing and price determination step, for each dispatch:
a step, performed by the distributor of reading using suitable equipment the identification information of said dispatch contained in the identification means of said dispatch placed on said dispatch
a step, performed by the distributor of verifying the validity of the identification information of the dispatch read in said identification means of said dispatch
if said verification step is a success triggering said weighing and necessary franking price determination step, performed by the distributor to route said dispatch to the recipient according to the dispatch options and the complementary services requested by the user for said dispatch
wherein said verification step by the distributor consists in the verification of the presence, in said data table of valid rank numbers, of said shipping rank identification part read in said identification means of said dispatch.

13. Method of franking and tracking dispatches, according to claim 9, further comprising prior to said weighing and price determination step, for each dispatch:
a step, performed by the distributor of reading using suitable equipment the identification information of said dispatch contained in the identification means of said dispatch placed on said dispatch
a step, performed by the distributor of verifying the validity of the identification information of the dispatch read in said identification means of said dispatch,
if said verification step is a success triggering said weighing and necessary franking price determination step, performed by the distributor to route said dispatch to the recipient, according to the dispatch options and the complementary services requested by the user for said dispatch,
wherein said verification step by the distributor consists in the verification of the validity of the digital signature read in the identification means of said dispatch at least with respect to the shipping rank identification part of the identification information of said dispatch read in the identification means of said dispatch.

14. Method of franking and tracking dispatches, according to claim 10 further comprising prior to said weighing and price determination step, for each dispatch:
a step, performed by the distributor of reading, using suitable equipment the identification information of said dispatch contained in the identification means of said dispatch placed on said dispatch
a step, performed by the distributor of verifying the validity of the identification information of the dispatch read in said identification means of said dispatch
if said verification step is a success triggering said weighing and necessary franking price determination step, performed by the distributor to route said dispatch to the recipient according to the dispatch options and the complementary services requested by the user for said dispatch,
wherein said verification step by the distributor consists in the verification of the matching of the validation code read in the identification means of said dispatch with the “control” validation code obtained by reading, in the data table of validation codes corresponding to the user of said dispatch and stored in the data table of users, the validation code corresponding to said identification part of the shipping rank of said dispatch read in said identification means of said dispatch.

15. Method of franking and tracking dispatches, according to claim 2, further comprising prior to said weighing and price determination step, for each dispatch:
a step, performed by the distributor, of reading using suitable equipment the identification information of said dispatch contained in the identification means of said dispatch placed on said dispatch,
a step, performed by the distributor, of verifying the validity of the identification information of the dispatch read in said identification means of said dispatch
if said verification step is a success, triggering said weighing and necessary franking price determination step, performed by the distributor, to route said dispatch to the recipient, according to the dispatch options and the complementary services requested by the user for said dispatch,
wherein, for each dispatch, said identification information of said dispatch contained in the identification means of said dispatch further comprises an identification part of the user sender of said dispatch, which is invariable and unique for each user, and in that said verification step can further comprise the verification of this identification data of the user.

16. Method of franking and tracking dispatches, according to claim 1 comprising, for each dispatch, subsequent to said weighing and franking price determination step, an additional step, performed by the distributor, of placing, by means of suitable equipments, a franking means having a market value corresponding to said previously determined franking price.

17. Method of franking and tracking dispatches, according to claim 1 comprising, for each dispatch, subsequent to said weighing and franking price determination step, an additional step, performed by the distributor, of placing, by means of suitable equipment, means for dating the custody exchange of the dispatch, said dating means corresponding to an “electronic date stamp” or to a “electronic seal”.

18. Method of franking and tracking dispatches according to claim 1 further comprising, at the time of said franking price determination step, for each dispatch by the distributor, a step of calculating the distance between the point of deposit of said dispatch by the user and the destination address of said dispatch, and in that said franking price determination is also performed as a function of said calculated distance.

19. Method of franking and tracking dispatches, according to claim 1, wherein, for each dispatch, said identification information of said dispatch contained in said identification means placed on said dispatch at the time of said pre-franking step further comprises a part for ordering service options and complementary services, which is variable for each dispatch.

20. Method of franking and tracking dispatches, according to claim 19, wherein, for each dispatch, said identification information of the dispatch contained in said identification means of the dispatch further contains, in the service options and complementary services order part, a part for ordering a service option for automatic sending of an acknowledgment of receipt to the user when said mail is given to the recipient.

21. Method of franking and tracking dispatches, according to claim 20, further comprising, for each dispatch:
an optional step of indicating, on said dispatch, during the pre-franking step of said dispatch, a distinctive visual mark on said dispatch if the service options and complementary services order part of said dispatch contained in the identification means of said dispatch contains a service option order part for automatic sending of an acknowledgment of receipt to the user, and if said option has been activated,
a step, performed by the IS of the distributor, of automatically sending an electronic “acknowledgment of receipt” message to the user via at least one telecommunications network if said dispatch is correctly given to the recipient, and if said dispatch contains said visual mark, or if the service options and complementary services order part of said dispatch contained in the identification means of said dispatch contains a service option order part for automatic sending of an acknowledgment of receipt to the user, and said option is activated for said dispatch.

22. Method of franking and tracking dispatches, according to claim 1, wherein, for each dispatch, said step of generating and placing the identification means of said dispatch consists in programming an RFID chip by suitable equipment, wherein said RFID chip can be already incorporated in the dispatch packaging or inserted beforehand or not into the dispatch, or subsequently glued to said dispatch, and said chip further comprises, after said programming, said identification information of said dispatch.

23. Method of franking and tracking dispatches, according to claim 1, wherein, for each dispatch, said step of generating and placing the identification means on said dispatch consists in printing, by suitable equipment, a bar code to be placed on or glued to said dispatch, wherein said bar code can be printed directly on said dispatch, and wherein said bar code further comprises said identification information of said dispatch in the form of a bar code.

24. Method of franking and tracking dispatches, according to claim 1, comprising, for each dispatch, subsequent to said weighing and franking price determination step, a step of automated sending, by the IS of the distributor, of an electronic “acknowledgment of franking” message to the user for said dispatch via at least one telecommunications network, wherein said electronic message can contain all or part of the identification information of said dispatch, and can also contain all or part of the information resulting from the weighing and franking price calculation step for said dispatch.

25. Method of franking and tracking dispatches, according to claim 1, comprising, for each dispatch, subsequent to said weighing and franking price determination step, a step of invoicing said price to the user by a means of payment.

26. Method of franking and tracking dispatches, according to claim 25, wherein, for each dispatch, said invoicing step is performed from the sending by the user of a surtaxed SMS+, EMS+, MMS+, or Audiotel (Premium Service) telephone message to the IS of the distributor via at least one telecommunications network, or by receipt by the user of the “acknowledgment of franking” message of said dispatch sent by the IS of the distributor in the form of an SMS+, MMS+, or EMS+ message via at least one telecommunications network, the sending or the receipt of said SMS+, EMS+, MMS+, or audiotel message making it possible to perform a micro-payment by the user for the cost of franking said dispatch.

27. Method of franking and tracking dispatches, according to claim 2, wherein, for each dispatch, said generation of the rank identification part is a pseudo-random generation.

28. Method of franking and tracking dispatches, according to claim 2, wherein said user identification step is performed by the authentication of the user on said equipment.

29. Method of franking and tracking dispatches, according to claim 1, wherein said suitable equipment of each user can contain a chip card containing all parameterization information required for the operation of the method, wherein said equipment can also incorporate data transmission means compatible with wireless or hardwired telecommunications networks.

30. Method of franking and tracking dispatches, according to claim 16, wherein, for each dispatch, if said identification means of said dispatch is constituted by an RFID chip, said step of placing a franking means having a market value or of placing a dating means is replaced by a step of partially reprogramming said RFID chip constituting said identification means of said dispatch, wherein said reprogramming step makes it possible to add the required additional data, to implement said “electronic dating” means or said “electronic stamp” franking means in the identification means of said dispatch in addition to the identification information of said dispatch.

31. Method of franking and tracking dispatches, according to claim 3, wherein said transmissions of messages or said transmissions of information between the IS of the distributor and the user are performed over at least one telecommunications network.

32. System permitting the implementation of the method according to claim 1, comprising at least one database presenting a data table of validated numbers listing the validated shipping rank identifiers and the other identification information of the dispatches, a table listing the dispatches for which an acknowledgment of receipt message to the user has been requested, a data table of users listing the personal information of the users and means capable of processing, according to the data from said database, dispatches provided with pre-franking orders containing rank identification data and to perform the weighing and franking price determination of said dispatches if the rank identification data are valid with respect to the data contained in said database.
